(19) United States
(12) Patent Application Publication
(10) Pub. No.: US 2024/0022093 A1
(43) Pub. Date: Jan. 18, 2024

(54) FIXING AND SHOCK-ABSORBING PROTECTIVE DEVICE AND CHARGING DEVICE

(71) Applicant: CHANGCHUN JETTY AUTOMOTIVE PARTS CORPORATION, Changchun City, Jilin (CN)

(72) Inventor: Chao Wang, Changchun, Jilin (CN)

(21) Appl. No.: 18/255,820

(22) PCT Filed: Nov. 2, 2021
(86) PCT No.: PCT/CN2021/128047

§ 371 Date: Jun. 2, 2023

(30) Foreign Application Priority Data
Dec. 17, 2020 (CN) 202011494648.0

(51) Int. Cl. H02J 7/00

(52) U.S. Cl. CPC H02J 7/0042

(57) ABSTRACT

A fixing and shock-absorbing protective device and a charging device. The fixing and shock-absorbing protective device comprises a first mounting member, which is provided with a first clamping mechanism for fixing a circuit board and a first mounting hole for mounting a body structure of the first mounting member, and a deformation amount of the first mounting member after being stressed is 0.015 mm to 9.30 mm. In the fixing and shock-absorbing protective device according to the present disclosure, the rigid contact of the internal components of the electric or charging device during drop or collision is converted into an elastic buffer contact by means of the first clamping mechanism of the first mounting member, so that the stress on the electric or charging device during drop or collision is effectively decreased, and the damage probability of the internal electronic component of the electric or charging device is greatly reduced.

The present disclosure claims priority to Chinese Patent Application No. 202011494648.0, entitled ‘fixing and shock-absorbing protective device and charging device’, and filed on Dec. 17, 2020, which is hereby incorporated by reference in its entirety.

### TECHNICAL FIELD

The present disclosure relates to the technical field of fixing and shock-absorbing protection for movable electric and charging devices, and particularly to a fixing and shock-absorbing protective device and a charging device.

### BACKGROUND

With the advent of the 5G era, more and more movable electric and charging devices are used in modern society. Compared with the fixed electric and charging devices, the movable electric and charging devices are at risk of being dropped and collided during movement. Once dropped or collided, the electric and charging device will suffer functional damage, functional failure, or even serious safety accidents such as on fire. Up to now, there is no technical means to preventively solve the above problem of the electric and charging devices.

Therefore, it is an urgent technical problem to be solved by those skilled in the art to prevent the problem such as functional damage or functional failure of the electric and charging devices.

### SUMMARY

An objective of the present disclosure is to provide a fixing and shock-absorbing protective device and a charging device, which can solve the problem of functional damage or functional failure of an electric or charging device due to being dropped or collided.

In order to solve the above technical problem, the present disclosure provides a fixing and shock-absorbing protective device, including a first mounting member provided with a first clamping mechanism for fixation. A deformation amount of the first mounting member after being stressed is 0.015 mm to 9.30 mm.

In the fixing and shock-absorbing protective device according to the present disclosure, the rigid contact of the internal components of the electric or charging device during drop or collision is converted into an elastic buffer contact by means of the first clamping mechanism of the first mounting member, and by means of the accurately limited deformation amount of the first mounting member after being stressed through a series of inventive experiments, so that the stress on the electric or charging device during drop or collision is effectively decreased, the damage probability of the internal electronic component of the electric or charging device is greatly reduced, the normal function of the electric or charging device is well protected, and the electric or charging device is safer during movement. The charging device, the housing, and the fixing and shock-absorbing protective device mounted in the housing according to the present disclosure have the above advantageous effects.

### BRIEF DESCRIPTION OF THE DRAWINGS

For a clearer illustration of technical features in the embodiments of the present disclosure or the prior art, a brief description of the drawings for the embodiments or the prior art will be given below. Obviously, the drawings described below involve only some embodiments of this disclosure. For those of ordinary skill in the art, other drawings can be derived from these drawings without any inventive efforts.

FIG. 1 illustrates an overall structural diagram according to a specific embodiment of the present disclosure;

FIG. 2 illustrates a top view of a structure illustrated in FIG. 1;

FIG. 3 illustrates a structural diagram of a first mounting member illustrated in FIG. 1.

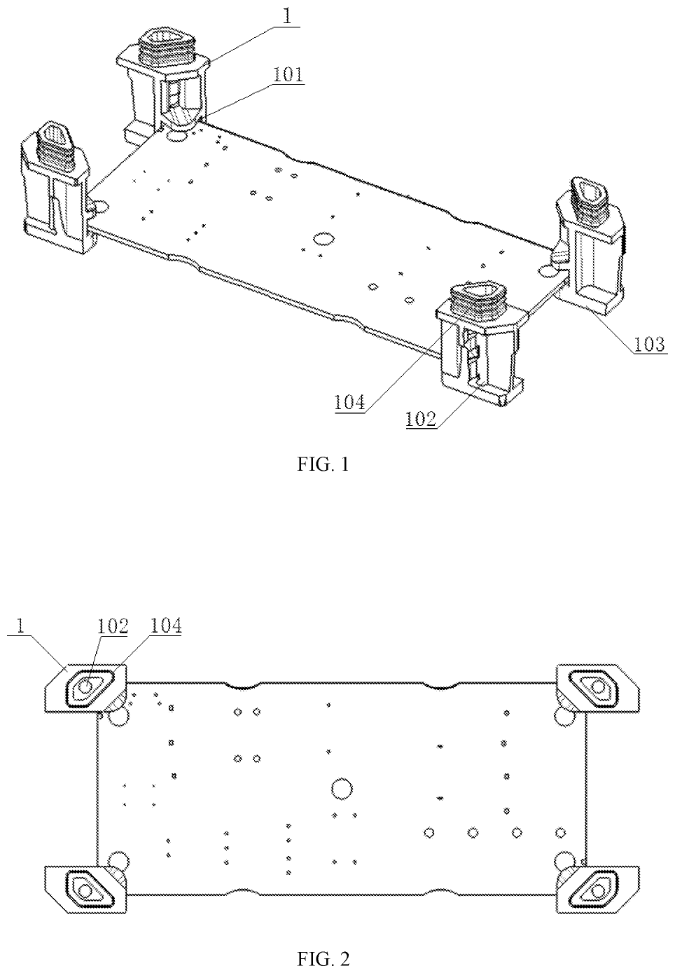

In FIGS. 1 to 3:
1: first mounting member; 101: first clamping mechanism; 102: first mounting hole; 103: bearing seat; 104: buffer structure.

### DETAILED DESCRIPTION

The technical solutions in the embodiments of the present disclosure will be clearly and completely described below with reference to the drawings for the embodiments of the present disclosure. Obviously, the described embodiments are only a part, rather than all, of the embodiments of the present disclosure. All other embodiments derived by persons skilled in the art from the embodiments of the present disclosure without making inventive efforts shall fall within the scope of the present disclosure.

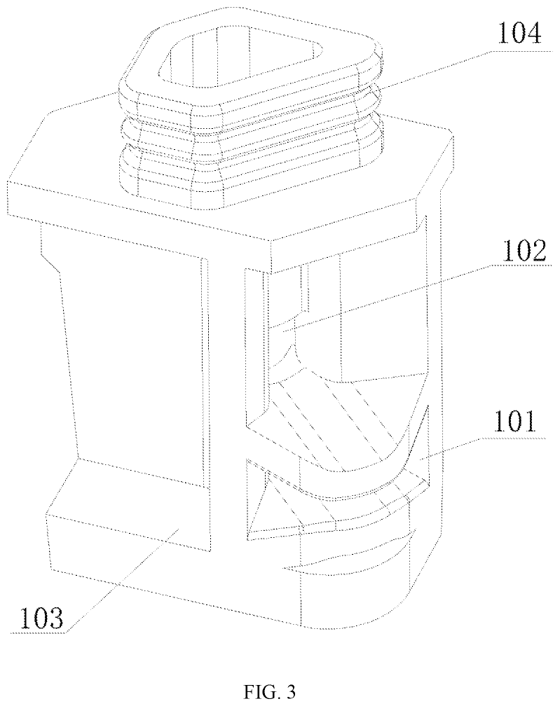

Referring to FIGS. 1 to 3, in which FIG. 1 illustrates an overall structural diagram according to a specific embodiment of the present disclosure, FIG. 2 illustrates a top view of a structure illustrated in FIG. 1, and FIG. 3 illustrates a structural diagram of a first mounting member illustrated in FIG. 1.

According to a specific embodiment of the present disclosure, the fixing and shock-absorbing protective device includes a first mounting member 1, which is provided with a first clamping mechanism 101 for fixing a circuit board and a first mounting hole 102 for mounting a body structure of the first mounting member 1.

The first mounting member 1 is preferably a flexible rubber body, with a preferred deformation amount of 0.015 mm to 9.30 mm. Of course, any other material with a protective performance may also be selected. The first mounting member 1 is provided with a mounting hole, i.e., the first mounting hole 102 of the first mounting member 1 may be fitted with a screw to fix the body structure of the first mounting member 1 with a housing of an electric or charging device. Then, the circuit board is clamped and fixed in the first clamping mechanism 101, so that the circuit board is fixed inside the housing of the electric or charging device. The first mounting member 1 made of flexible rubber can better release and absorb the impact force generated by the deformation of the circuit board itself due to being heated or cooled, so as to better protect the circuit board. Of course, the force acting on the first mounting member 1 is usually the impact caused by the dropping of the charging device during use.

Referring to Table 1, in which drop experiment conditions are as follows: dropped for 100 times at a normal temperature of 25° C.; stored for 30 minutes and dropped for 60 times at a low temperature of −40° C.; stored for 30 minutes and dropped for 80 times at a high temperature of 50° C.; stored for 30 minutes at a low temperature of −40° C., then transported to be stored for 30 minutes at a high temperature of 50° C. (the transport time is less than 30 s), dropped for 10 times, and cycled for 8 times.

TABLE 1
Drop Experiment -- Experimental Test of Deformation Amount
on Hardware Damage Rate and Functional Failure Rate
Drop Experiment (Normal Temperature, High Temperature, Low
Temperature, Alternating Temperature)- Experimental Test of Deformation
Amount on Hardware Damage Rate and Functional Failure Rate

Item

| | | | | | | | | | | |
|---|---|---|---|---|---|---|---|---|---|---|
| Deformation Amount | 0 | 0.005 | 0.01 | 0.015 | 0.02 | 0.025 | 0.03 | 0.035 | 0.04 | 0.045 |
| Hardware Damage | 0.37 | 0.25 | 0.130 | 0.000 | 0.000 | 0.000 | 0.000 | 0.000 | 0.000 | 0.000 |
| Rate % | | | | | | | | | | |
| Functional Failure | 0.120 | 0.090 | 0.070 | 0.000 | 0.000 | 0.000 | 0.000 | 0.000 | 0.000 | 0.000 |
| Rate % | | | | | | | | | | |
| Deformation Amount | 0.050 | 0.055 | 0.060 | 0.065 | 0.070 | 0.075 | 0.080 | 0.085 | 0.090 | 0.095 |
| Hardware Damage | 0.000 | 0.000 | 0.000 | 0.000 | 0.000 | 0.000 | 0.000 | 0.000 | 0.000 | 0.000 |
| Rate % | | | | | | | | | | |
| Functional Failure | 0.000 | 0.000 | 0.000 | 0.000 | 0.000 | 0.000 | 0.000 | 0.000 | 0.000 | 0.000 |
| Rate % | | | | | | | | | | |
| Deformation Amount | 0.100 | 0.200 | 0.300 | 0.400 | 0.500 | 0.600 | 0.700 | 0.800 | 0.900 | 1.000 |
| Hardware Damage | 0.000 | 0.000 | 0.000 | 0.000 | 0.000 | 0.000 | 0.000 | 0.000 | 0.000 | 0.000 |
| Rate % | | | | | | | | | | |
| Functional Failure | 0.000 | 0.000 | 0.000 | 0.000 | 0.000 | 0.000 | 0.000 | 0.000 | 0.000 | 0.000 |
| Rate % | | | | | | | | | | |
| Deformation Amount | 1.100 | 1.200 | 1.300 | 1.400 | 1.500 | 1.600 | 1.700 | 1.800 | 1.900 | 2.000 |
| Hardware Damage | 0.000 | 0.000 | 0.000 | 0.000 | 0.000 | 0.000 | 0.000 | 0.000 | 0.000 | 0.000 |
| Rate % | | | | | | | | | | |
| Functional Failure | 0.000 | 0.000 | 0.000 | 0.000 | 0.000 | 0.000 | 0.000 | 0.000 | 0.000 | 0.000 |
| Rate % | | | | | | | | | | |
| Deformation Amount | 2.200 | 2.400 | 2.600 | 2.800 | 3.000 | 3.200 | 3.400 | 3.600 | 3.800 | 4.000 |
| Hardware Damage | 0.000 | 0.000 | 0.000 | 0.000 | 0.000 | 0.000 | 0.000 | 0.000 | 0.000 | 0.000 |
| Rate % | | | | | | | | | | |
| Functional Failure | 0.000 | 0.000 | 0.000 | 0.000 | 0.000 | 0.000 | 0.000 | 0.000 | 0.000 | 0.000 |
| Rate % | | | | | | | | | | |
| Deformation Amount | 4.200 | 4.400 | 4.600 | 4.800 | 5.000 | 5.200 | 5.400 | 5.600 | 5.800 | 6.000 |
| Hardware Damage | 0.000 | 0.000 | 0.000 | 0.000 | 0.000 | 0.000 | 0.000 | 0.000 | 0.000 | 0.000 |
| Rate % | | | | | | | | | | |
| Functional Failure | 0.000 | 0.000 | 0.000 | 0.000 | 0.000 | 0.000 | 0.000 | 0.000 | 0.000 | 0.000 |
| Rate % | | | | | | | | | | |
| Deformation Amount | 6.200 | 6.400 | 6.600 | 6.800 | 7.000 | 7.200 | 7.400 | 7.600 | 7.800 | 8.000 |
| Hardware Damage | 0.000 | 0.000 | 0.000 | 0.000 | 0.000 | 0.000 | 0.000 | 0.000 | 0.000 | 0.000 |
| Rate % | | | | | | | | | | |
| Functional Failure | 0.000 | 0.000 | 0.000 | 0.000 | 0.000 | 0.000 | 0.000 | 0.000 | 0.000 | 0.000 |
| Rate % | | | | | | | | | | |
| Deformation Amount | 8.100 | 8.200 | 8.300 | 8.400 | 8.500 | 8.600 | 8.700 | 8.800 | 8.900 | 9.000 |
| Hardware Damage | 0.000 | 0.000 | 0.000 | 0.000 | 0.000 | 0.000 | 0.000 | 0.000 | 0.000 | 0.000 |
| Rate % | | | | | | | | | | |
| Functional Failure | 0.000 | 0.000 | 0.000 | 0.000 | 0.000 | 0.000 | 0.000 | 0.000 | 0.000 | 0.000 |
| Rate % | | | | | | | | | | |
| Deformation Amount | 9.100 | 9.200 | 9.300 | 9.400 | 9.500 | 9.600 | 9.700 | 9.800 | 9.900 | 10.000 |
| Hardware Damage | 0.000 | 0.000 | 0.000 | 0.110 | 0.210 | 0.290 | 0.330 | 0.420 | 0.530 | 0.840 |
| Rate % | | | | | | | | | | |
| Functional Failure | 0.000 | 0.000 | 0.000 | 0.050 | 0.083 | 0.103 | 0.115 | 0.133 | 0.159 | 0.203 |
| Rate % | | | | | | | | | | |

As can be seen from the above table, through a series of inventive experiments, it is found that when the deformation amount of the first mounting member 1 is less than 0.015 mm, the hardware damage rate is greater than 0.13% and the functional failure rate is greater than 0.070%; when the deformation amount is 0.015 to 9.30 mm, both the hardware damage rate and the functional failure rate are zero; when the deformation amount is greater than 9.30 mm, the hardware damage rate is greater than 0.110%, and the functional failure rate is greater than 0.050%. Along with the continuous increase of the deformation amount, the hardware damage rate and the functional failure rate increase by leaps and bounds, which has a great affection on the performance and life of the product, and in severe cases causes a sharp decrease of the life of the product or even a failure. Therefore, in this embodiment, it is preferable that the deformation amount of the first mounting member 1 ranges from 0.015 mm to 9.30 mm. Compared with the general cognition that the shock-absorbing protection effect improves as the deformation amount after being stressed increases, the present disclosure proves, through the above series of inventive experiments, that it is necessary to limit the range of the deformation amount of the first mounting member 1 to obtain the optimal shock-absorbing protection effect.

Specifically, the first mounting members 1 are placed at corresponding positions of the circuit board, so that the circuit board is entirely clamped through the first mounting holes 102 of the first mounting members 1, so as to form an integral mounted body. The screws are fitted with the first mounting holes 102, respectively, so that the circuit board is mounted and fixed inside the housing of the electric or charging device. Since there is no direct contact between the circuit board and the inner wall or the housing of the electric or charging device, the first mounting member 1 can greatly increase the buffering capacity of the circuit board under an external impact, and better protect the circuit board.

In order to optimize the buffering capacity against the impact force and the fixing stability of the fixed protective device in the above embodiment, a bottom of the first mounting member 1 is provided with a bearing seat 103, which is fixedly connected to the electric or charging device. The first mounting member 1 has an I-shaped support structure and is connected to the bearing seat 103, so as to reduce the impact on the circuit board while making the fixation of the circuit board more stable, thereby better ensuring the working performance of the circuit board.

Further, the first mounting hole 102 is disposed along a height direction of the first mounting member 1, and the first mounting hole 102 is fit with the screw to fix the first mounting member 1 to the electric or charging device.

On this basis, a top of the first mounting member 1 is provided with a buffer structure 104, which abuts against an upper cover of the electric or charging device. When the upper cover of the electric or charging device is subjected to an impact, the impact may be transmitted to the bearing seat 103 by the buffer structure 104 via the body of the first mounting member 1, thereby effectively preventing the circuit board from being damaged and improving the safety performance thereof. Of course, a surface of the first clamping mechanism 101 is provided with a concave-convex structure, which enhances the mounting stability of the first mounting member 1 for fixing the circuit board or other mounted members.

Specifically, the material of the first mounting member 1 at least includes one or more selected from the group consisting of a thermoplastic material, a thermosetting material, a rubber elastomer, and a composite material. Please refer to the prior art for the above materials, which will not be repeated here.

Further, the material of the flexible rubber body includes one or more selected from the group consisting of natural rubber, styrene-butadiene rubber, nitrile rubber, silicone butadiene rubber, isoprene rubber, ethylene-propylene rubber, chloroprene rubber, butyl rubber, fluororubber, polyurethane rubber, polyacrylate rubber, chlorosulfonated polyethylene rubber, epichlorohydrin rubber, chlorinated polyene rubber, chlorosulfide rubber, styrene butadiene rubber, butadiene rubber, hydrogenated Buna-N rubber and polysulfide rubber. Please refer to the prior art for the above materials, which will not be repeated here.

Referring to Table 2, the height of the first mounting member 1 is not greater than mm. Of course, the height of the first mounting member 1 may also be designed according to the internal space size of the box, and is not limited to the above situation.

TABLE 2
Experimental Test of Height on Functional Failure Rate

| | Cushion pads with different heights (mm), | | | | |
|---|---|---|---|---|---|
| Performance | 10 pieces for each height | | | | |
| Height | 1 | 3 | 5 | 7 | 9 |
| Completion pass rate % | 99.7 | 100 | 100 | 100 | 100 |
| Functional failure rate % | 0 | 0 | 0 | 0 | 0 |
| Height | 11 | 13 | 15 | 17 | 19 |
| Completion pass rate % | 100 | 100 | 100 | 100 | 100 |
| Functional failure rate % | 0 | 0 | 0 | 0 | 0 |
| Height | 21 | 23 | 25 | 27 | 29 |
| Completion pass rate % | 100 | 100 | 100 | 100 | 100 |
| Functional failure rate % | 0 | 0 | 0 | 0 | 0 |
| Height | 31 | 33 | 35 | 37 | 39 |
| Completion pass rate % | 100 | 100 | 100 | 100 | 100 |
| Functional failure rate % | 0 | 0 | 0 | 0 | 0 |
| Height | 41 | 43 | 45 | 47 | 49 |
| Completion pass rate % | 100 | 100 | 100 | 100 | 100 |
| Functional failure rate % | 0 | 0 | 0 | 0 | 0 |
| Height | 51 | 53 | 55 | 57 | 59 |
| Completion pass rate % | 100 | 100 | 100 | 100 | 100 |
| Functional failure rate % | 0 | 0 | 0 | 0 | 0 |
| Height | 61 | 63 | 65 | 67 | 69 |
| Completion pass rate % | 100 | 100 | 100 | 100 | 100 |
| Functional failure rate % | 0 | 0 | 0 | 0 | 0 |
| Height | 71 | 73 | 75 | 77 | 79 |
| Completion pass rate % | 100 | 100 | 100 | 100 | 100 |
| Functional failure rate % | 0 | 0 | 0 | 0 | 0 |
| Height | 81 | 83 | 85 | 87 | 89 |
| Completion pass rate % | 100 | 100 | 100 | 100 | 100 |
| Functional failure rate % | 0 | 0 | 0 | 0 | 0 |
| Height | 90 | 91 | 92 | 93 | 94 |
| Completion pass rate % | 100 | 100 | 100 | 100 | 100 |
| Functional failure rate % | 0 | 0 | 0 | 0 | 0 |
| Height | 95 | 96 | 97 | 98 | 99 |
| Completion pass rate % | 100 | 96.2 | 93.2 | 90.2 | 88.2 |
| Functional failure rate % | 0 | 0.31 | 0.66 | 1.03 | 1.4 |

As can be seen from the above table, through a series of inventive experiments, it is found that when the height is 1 to 95 mm, the functional failure rate is 0, and when the height is greater than 95 mm, the functional failure rate is greater than 0.31%. Along with the continuous increase of the height, the functional failure rate increases by leaps and bounds, which has a great affection on the performance and life of the product, and in severe cases causes a sharp decrease of the life of the product or even a failure. Therefore, in this embodiment, it is preferable that the height of the first mounting member 1 is greater than 0 mm and less than or equal to 95 mm.

Referring to Table 3, a ratio of a projection area of the first clamping mechanism 101 along a height direction of the first mounting member 1 to a contact area of a contact region between the first clamping mechanism 101 and a fixed object is not greater than 46, which ensures the clamping stability of the first clamping mechanism 101 while optimizing the mounting space inside the box occupied by the entire first clamping mechanism 101.

TABLE 3
Drop Experiment -- Experimental Test of Ratio of
Projection Area to Contact Area on Hardware Damage Rate
Change of ratio of projection area to contact area

| Item | Parameters and statistical data | | | | | |
|---|---|---|---|---|---|---|
| Ratio of projection area to | 0 | 2 | 4 | 6 | 8 | 10 |
| contact area | | | | | | |
| Hardware damage failure rate (%) | 0 | 0 | 0 | 0 | 0 | 0 |
| Ratio of projection area to | 12 | 14 | 16 | 18 | 20 | 22 |
| contact area | | | | | | |
| Hardware damage failure rate (%) | 0 | 0 | 0 | 0 | 0 | 0 |
| Ratio of projection area to | 24 | 26 | 28 | 30 | 32 | 34 |
| contact area | | | | | | |
| Hardware damage failure rate (%) | 0 | 0 | 0 | 0 | 0 | 0 |
| Ratio of projection area to | 36 | 38 | 40 | 41 | 42 | 43 |
| contact area | | | | | | |
| Hardware damage failure rate (%) | 0 | 0 | 0 | 0 | 0 | 0 |
| Ratio of projection area to | 44 | 45 | 46 | 47 | 48 | 49 |
| contact area | | | | | | |
| Hardware damage failure rate (%) | 0 | 0 | 0 | 0.13 | 0.41 | 0.96 |

As can be seen from the above table, through a series of inventive experiments, it is found that when the ratio of the projection area of the first clamping mechanism 101 to the contact area with the fixed object is less than 46, the hardware damage failure rate is 0; when the ratio of the projection area of the first clamping mechanism 101 to the contact area with the fixed object is greater than 46, the hardware damage failure rate is greater than 0.13%. Along with the continuous increase of the ratio, the hardware damage failure rate increases by leaps and bounds, which has a great affection on the performance and life of the product. Therefore, in this embodiment, it is preferable that the ratio of the projection area of the first clamping mechanism 101 to the contact area with the fixed object ranges from 0 to 46.

Meanwhile, in order to improve the buffer space between the circuit board and the electric or charging device, the first mounting members 1 are correspondingly mounted at the four corners of the circuit board, respectively, so as to better reduce the impact on the circuit board and make the circuit board be safer.

A specific embodiment of the present disclosure further provides a charging device including the fixing and shock-absorbing protective device. Please refer to the prior art for the structures of other parts of the charging device, which will not be repeated here.

It should be noted that the material of the housing at least includes one or more selected from the group consisting of a thermoplastic material, a thermosetting material, a rubber elastomer, and a composite material. Specifically, the material of the housing includes one or more selected from the group consisting of polyamide, polyethylene, polypropylene, polystyrene, polymethyl methacrylate, polyvinyl chloride, ethylene propylene diene monomer, nylon, polycarbonate, polytetrafluoroethylene, polyethylene glycol terephthalate, polyformaldehyde and polyvinyl chloride. Please refer to the prior art for the above materials, which will not be repeated here.

To sum up, the fixing and shock-absorbing protective device according to the embodiments mainly includes a first mounting member, which is provided with a first clamping mechanism for fixing a circuit board and a first mounting hole for mounting a body structure of the first mounting member. A deformation amount of the first mounting member after being stressed is 0.015 mm to 9.30 mm. In the fixing and shock-absorbing protective device according to the present disclosure, the rigid contact of the internal components of the electric or charging device during drop or collision is converted into an elastic buffer contact by means of the first clamping mechanism of the first mounting member, so that the stress on the electric or charging device during drop or collision is effectively decreased, the damage probability of the internal electronic components of the electric or charging device is greatly reduced, the normal function of the electric or charging device is well protected, and the electric or charging device is safer during movement. The charging device, the housing, and the fixing and shock-absorbing protective device mounted in the housing according to the present disclosure have the above advantageous effects.

The above description of the disclosed embodiments enables those skilled in the art to carry out or use the present disclosure. Many modifications to these embodiments will be obvious to those skilled in the art, and general principles defined herein can be implemented in other embodiments without departing from the spirit or scope of the present disclosure. Therefore, the present disclosure is not limited to the embodiments illustrated herein, but is to be accorded with the widest scope consistent with the principles and novel features disclosed herein.

1. A fixing and shock-absorbing protective device, comprising a first mounting member provided with a first clamping mechanism for fixation, wherein a deformation amount of the first mounting member after being stressed is 0.015 mm to 9.30 mm.

2. The fixing and shock-absorbing protective device according to claim 1, wherein the first mounting member is a flexible rubber body.

3. The fixing and shock-absorbing protective device according to claim 1, wherein the first mounting member is provided with a first mounting hole for mounting a body structure of the first mounting member.

4. The fixing and shock-absorbing protective device according to claim 3, wherein a bearing seat is provided on a bottom of the first mounting member.

5. The fixing and shock-absorbing protective device according to claim 4, wherein the first mounting hole is disposed along a height direction of the first mounting member.

6. The fixing and shock-absorbing protective device according to claim 1, wherein a buffer structure is provided on a top of the first mounting member.

7. The fixing and shock-absorbing protective device according to claim 1, wherein a surface of the first clamping mechanism is provided with a concave-convex structure.

8. The fixing and shock-absorbing protective device according to claim 1, wherein a height of the first mounting member is not greater than 95 mm.

9. The fixing and shock-absorbing protective device according to claim 1, wherein a material of the first mounting member at least comprises one or more selected from the group consisting of a thermoplastic material, a thermosetting material, a rubber elastomer and a composite material.

10. The fixing and shock-absorbing protective device according to claim 2, wherein a material of the flexible rubber body comprises one or more selected from the group consisting of natural rubber, styrene-butadiene rubber, nitrile rubber, silicone butadiene rubber, isoprene rubber, ethylene-propylene rubber, chloroprene rubber, butyl rubber, fluororubber, polyurethane rubber, polyacrylate rubber, chlorosulfonated polyethylene rubber, epichlorohydrin rubber, chlorinated polyene rubber, chlorosulfide rubber, styrene butadiene rubber, butadiene rubber, hydrogenated Buna-N rubber, and polysulfide rubber.

11. The fixing and shock-absorbing protective device according to claim 1, wherein a ratio of a projection area of the first clamping mechanism along a height direction of the first mounting member to an area of a contact region between the first clamping mechanism and a fixed object is not greater than 46.

12. A charging device, comprising a housing and the fixing and shock-absorbing protective device according to claim 1 mounted in the housing.

13. The charging device according to claim 12, wherein a material of the housing at least comprises one or more selected from the group consisting of a thermoplastic material, a thermosetting material, a rubber elastomer and a composite material.

14. The charging device according to claim 13, wherein the material of the housing comprises one or more selected from the group consisting of polyamide, polyethylene, polypropylene, polystyrene, polymethyl methacrylate, polyvinyl chloride, ethylene propylene diene monomer, nylon, polycarbonate, polytetrafluoroethylene, polyethylene glycol terephthalate, polyformaldehyde and polyvinyl chloride.
